(19) United States
(12) Patent Application Publication
(10) Pub. No.: US 2026/0355734 A1
(43) Pub. Date: Nov. 12, 2026

(54) HETEROGENOUS MATERIAL MIXING/DISPENSING DEVICE

(71) Applicant: BODITECH MED INC., Chuncheon-si, Gangwon-do (KR)

(72) Inventors: Byeong Chul KIM, Chuncheon-si, Gangwon-do (KR); Sang Hyun PARK, Chuncheon-si, Gangwon-do (KR)

(21) Appl. No.: 19/477,003

(22) PCT Filed: Mar. 14, 2024
(86) PCT No.: PCT/KR2024/095512

§ 371 Date: Oct. 20, 2025

(30) Foreign Application Priority Data
Apr. 18, 2023 (KR) 10-2023-0051008

(51) Int. Cl. B01L 3/00; B01F 35/30; B01F 35/71; B01F 101/23

(52) U.S. Cl. CPC B01L 3/502; B01F 35/712; B01F 35/7137; B01F 35/7179; B01F 2035/3511; B01F 2101/23; B01L 2200/026; B01L 2200/0689; B01L 2300/042; B01L 2300/044; B01L 2300/0672; B01L 2300/0832; B01L 2400/0406

(57) ABSTRACT

A heterogeneous material mixing and dispensing device includes a tube assembly including a soft tube body, filled with a first material, and having an inlet shielded by a shield and a piercer protruding from an inner end of the tube body axially; a nozzle assembly including a chamber filled with a second material and shielded with a second sealing film, and a nozzle for selectively opening an outlet of the nozzle; and a sample collector assembly collecting a fixed amount of liquid specimen sample using capillary action, insertable into the tube body. When the sample collector member is inserted into the tube body and the chamber is coupled to the tube body, the piercer pierces the second sealing film allowing the second material to flow for mixing with the first material, the second material, and the specimen sample, and the nozzle is opened to dispense a mixed solution.

### TECHNICAL FIELD

The present invention relates to a heterogeneous material mixing and dispensing device capable of safely and separately storing a plurality of different materials used by being mixed with each other, collecting a liquid specimen sample to be diagnosed or analyzed during use in fixed amounts, easily mixing the collected liquid specimen sample with the separately stored plurality of materials, and then dispensing the mixture.

### BACKGROUND ART

As is already known, various chemical or biochemical test methods are used to measure biological indices related to a specific disease, a general health condition, an infection, or the like. Such chemical or biochemical test methods are generally performed through multistage chemical reactions and physical manipulations using various reagents and tools.

For example, when detecting a biochemical such as occult blood, a specific chemical, or protein contained in feces or mucus, multistage physical manipulations are required that include collecting a sample, putting the collected sample in a certain container to cause the sample to react with one or more reagents, and then distributing the reacted sample from the container before applying the sample to a testing/reading device.

When a specimen sample to be analyzed, for example, blood, a detector antibody labelled with a fluorescent material or the like, and whole blood are used, a solution (reagent) to which a red blood cell lysis reagent is added is mixed at a fixed ratio and reacted, and the specimen sample is loaded to a sample pad of an analytical device or a cartridge and analyzed.

In this way, a mixed solution in which a plurality of different materials are mixed is often used as a solution used in chemical or biochemical tests. However, when a plurality of materials that are mixed and used for disease diagnosis or the like are mixed in advance, the mixture may evaporate or may easily spoil due to being vulnerable to moisture, and since accurate diagnosis or analysis is difficult in such cases, the plurality of materials should be separately stored in separate containers. In addition, at the time of testing, the separately stored plurality of materials and a specimen sample such as blood are measured using a tool such as a pipette and mixed.

Therefore, not only is it complicated to store various materials to be used as reagents or the like, the diagnosis or analysis task is quite complex. In particular, using a plurality of separate tools such as pipettes is inevitable for mixing and dispensing various different materials and mixing and dispensing a specimen sample together with the materials. In addition, there is a problem that different containers or tools should be used for storing and mixing heterogeneous materials and mixing and dispensing the mixed solution and a specimen sample.

Meanwhile, Related Art Document 1 discloses a dropper in which a tip portion causing a capillary phenomenon is provided on a lower end of a lower portion of an inflow tube having a boronic acid latex ball embedded therein, thereby allowing blood, the boronic acid latex ball, and a buffer solution to be mixed and dispensed using a single dropper.

However, Related Art Document 1 has problems that the dropper should be managed in a separate package because a front end of the tip portion is open due to characteristics of the dropper, and the dropper is unusable when two materials to be mixed are both liquids.

### DISCLOSURE

### Technical Problem

The present invention has been devised in consideration of the conventional problems described above and is directed to providing a heterogeneous material mixing and dispensing device capable of safely and separately storing a plurality of different materials to be used as, for example, diagnostic reagents or analytic reagents, collecting a liquid specimen sample in fixed amounts during diagnosis or analysis, easily mixing the collected sample with the separately stored heterogeneous materials, and then dispensing the mixture in fixed amounts.

The objectives of the present invention are not limited to that mentioned above, and other unmentioned objectives should be clearly understood by those of ordinary skill in the art based on the description below.

### Technical Solution

A heterogeneous material mixing and dispensing device according to the present invention for achieving the above objectives includes: a tube member including a tube body that is made of a soft material, is filled with a first material, and has an inlet shielded by a shielding means and a piercing part that protrudes a predetermined length from an inner bottom of the tube body in an axial direction; a nozzle member including a chamber part that is filled with a second material and has one end shielded with a second sealing film and a nozzle part that extends from the other end of the chamber part in the axial direction and communicates with an inner portion of the chamber part and selectively opening an outlet of the nozzle part; and a sample collector member that collects a liquid specimen sample in predetermined fixed amounts using capillary action and is able to be inserted into the tube body, wherein when the sample collector member is inserted into the tube body and the chamber part is coupled to the inlet of the tube body, the piercing part penetrates and pierces the second sealing film, allowing the second material to flow into the tube body and the first material, the second material, and the specimen sample to be mixed, and the nozzle part is opened to dispense a mixed solution.

According to one embodiment of the present invention, the shielding means may be made of a first sealing membrane that is press-fitted to the inlet of the tube body.

According to one embodiment of the present invention, the piercing part may have a +-shaped, Y-shaped, or T-shaped cross-section.

According to one embodiment of the present invention, at least one guide protrusion may be formed on an outer surface of the piercing part in a longitudinal direction, and the guide protrusion may be spaced a predetermined distance from a front end of the piercing part to, at the time of coupling between the tube member and the nozzle member, further widen the second sealing film penetrated by the piercing part and allow the second material to easily flow into the tube body.

According to one embodiment of the present invention, a leakage prevention protrusion coming into close contact with an outer surface of the chamber part may be provided on an inner surface of the tube body.

According to one embodiment of the present invention, a cutting head part closing the outlet of the nozzle part may be integrally provided on a front end of the nozzle part, and the cutting head part may be cut from the nozzle part through a cutting part formed to be indented from an outer surface of the nozzle part, thereby opening the nozzle part.

According to one embodiment of the present invention, the outlet of the nozzle part may be open and may be closed by a cap that is detachably coupled to a front end portion of the nozzle part.

According to one embodiment of the present invention, the sample collector member may be provided as a single sample collector member having a predetermined collection capacity or may be provided as a plurality of sample collector members with different collection capacities, and one of the plurality of sample collector members may be selected according to a volume of a specimen sample to be collected.

According to one embodiment of the present invention, the sample collector member may include a coupling part into which an outer circumference of the chamber part is inserted and may be able to be coupled to and separated from the nozzle member.

According to one embodiment of the present invention, a first handle part for rotating the nozzle member in a circumferential direction after coupling the nozzle member to an inlet of the tube member in the axial direction may be provided on the nozzle member.

According to one embodiment of the present invention, a second handle part for cutting the cutting head part may be provided on the cutting head part.

According to one embodiment of the present invention, the tube body and the chamber part may have an internal screw part and an external screw part that correspond to each other and may be coupled using a screw coupling method.

### Advantageous Effects

According to a heterogeneous material mixing and dispensing device of the present invention, since first and second materials to be mixed with each other can be separately stored in a tube member and a nozzle member that are coupled to each other at the time of use for diagnosis or analysis, a plurality of different materials to be used by being mixed in a chemical or biochemical test can be safely stored while separated from each other.

In addition, the separately stored plurality of materials can be easily mixed just by a simple operation of coupling the tube member and the nozzle member at the time of testing or analysis, a specimen sample such as blood that requires testing or analysis can be collected in fixed amounts without a separate tool, three or more materials, including the separately stored plurality of materials and the specimen sample, can be easily mixed together, and a mixed solution thereof can be easily dispensed in fixed amounts through a nozzle part.

Therefore, there is no need to use different containers or tools for storing, mixing, and dispensing a plurality of materials to be used by being mixed at the time of diagnosis or analysis, and in particular, collecting and mixing a specimen sample such as blood that requires diagnosis, or analysis also does not require a separate tool.

In addition, since the plurality of materials can each be sealed and stored in either of the tube member or the nozzle member, there is an advantage in that the plurality of materials can be safely stored and mixed/dispensed when the materials are a liquid and a liquid as well as when the materials are a liquid and a solid.

### DESCRIPTION OF DRAWINGS

FIG. 1 is an exploded perspective view of a heterogeneous material mixing and dispensing device according to the present invention.

FIG. 2 is an exploded cross-sectional view of the heterogeneous material mixing and dispensing device according to the present invention.

FIG. 3 is a perspective view of a coupling state of the heterogeneous material mixing and dispensing device according to the present invention.

FIG. 4 is a cross-sectional view along line IV-IV of FIG. 3.

FIG. 5 is a cross-sectional view along line V-V of FIG. 4.

(a) to (c) of FIG. 6 are schematic views illustrating a dispensing method of the heterogeneous material mixing and dispensing device according to the present invention.

(a) and (b) of FIG. 7 are excerpt views of main parts illustrating different forms of a piercing part of the heterogeneous material mixing and dispensing device according to the present invention.

FIG. 8 is a plan view illustrating an action of the piercing part illustrated in FIG. 7.

FIG. 9 is an excerpt view of a main part illustrating another embodiment of a nozzle part closing structure of the heterogeneous material mixing and dispensing device according to the present invention.

### MODES OF THE INVENTION

Specific features and other advantages of the present invention and methods of achieving them will be apparent with reference to the embodiments described below in detail with the accompanying drawings. However, the present invention is not limited to the embodiments disclosed below and can be implemented in various different forms, the present embodiments only make the disclosure of the present invention complete and are provided to fully inform those of ordinary skill in the art to which the present invention pertains of the scope of the invention, and the present invention is only defined by the scope of the claims. Like reference numerals refer to like components throughout the specification.

In embodiments of the present invention, “first material” and/or “second material” may be liquid or solid reaction reagents, specifically, silica particles, proteins, amino acids, nucleic acids, lipids, carbohydrates, metabolites, reagents used as supports, antibodies that selectively separate proteins, detectors, blockers, optical signal enhancers, optical signal quenchers, or other reagents, but are not limited thereto.

Hereinafter, a heterogeneous material mixing and dispensing device according to embodiments of the present invention will be described with reference to the accompanying drawings.

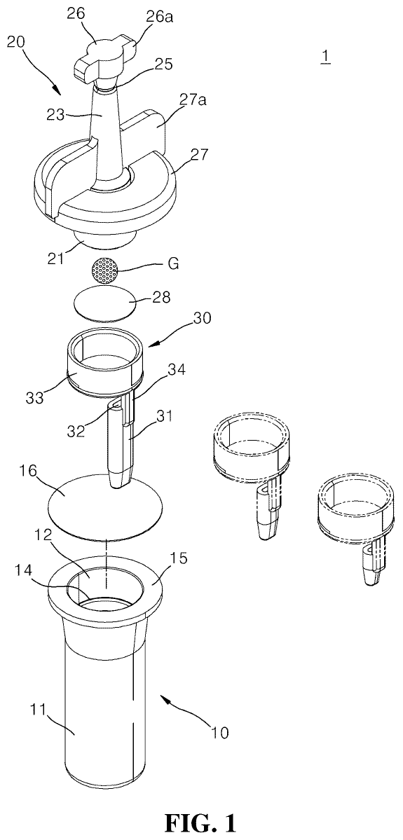

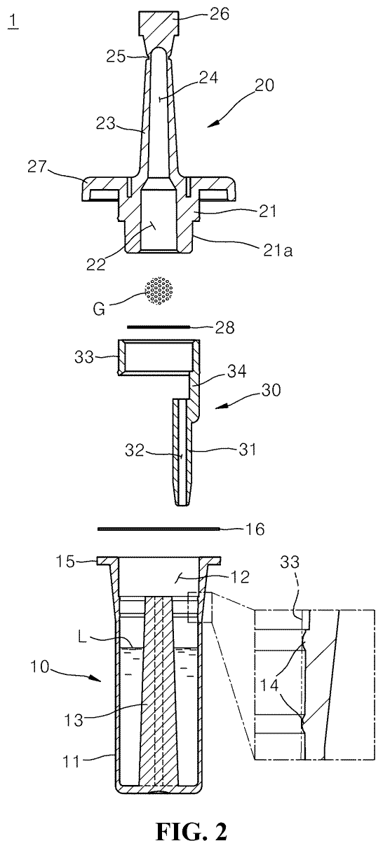

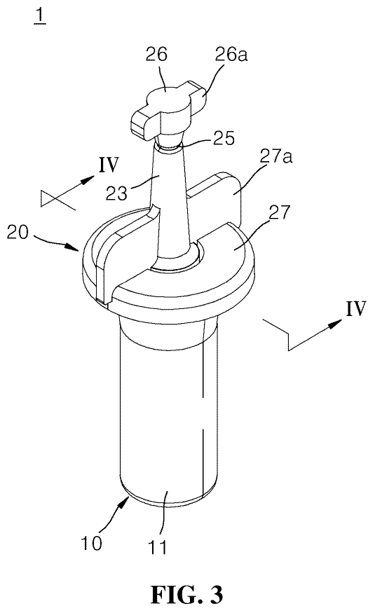

In FIGS. 1 to 4, a heterogeneous material mixing and dispensing device 1 according to the present invention may be configured to include a tube member 10, a nozzle member 20 coupled to the tube member 10, and a sample collector member 30 attached to the nozzle member 20 to collect a liquid specimen sample such as blood in fixed amounts.

The tube member 10 may be filled with and store a first material L in a sealed state. The tube member 10 may be a configuration including a tube body 11 that has a first filling space 12 therein and a piercing part 13 that pierces and perforates a second sealing film 28, which will be described below, at the time of coupling between the tube member 10 and the nozzle member 20.

The tube body 11 may have the form of a long cylindrical container to facilitate gripping and dispensing and has one end that is open to serve as an inlet of the first filling space 12. The open inlet of the tube body 11 is closed by a shielding means to safely seal the first material L filled therein.

The shielding means may be implemented in various forms. For example, the shielding means may be configured as a typical stopper (not illustrated) or may be configured as a first sealing film 16 press-fitted to the opening of the tube body 11 as illustrated.

Here, the first sealing film 16 may be a configuration that is torn by a chamber part 21 of the nozzle member 20 at the time of coupling between the tube member 10 and the nozzle member 20, or may be in the form of a sticker that can be removed at the time of coupling between the two, and may be either one of the above.

However, in the present invention, considering that the sample collector member 30 collects a sample such as blood using capillary action while coupled to the nozzle member 20 and then is coupled to the tube member 10, configuring the first sealing film 16 in a peelable form like a sticker may be more favorable. Of course, the first sealing film 16 may be configured in a form that can be torn due to coupling to the nozzle member 20, but in this case, there is a need to appropriately tear the first sealing film 16 using a separate tool in order to allow the sample collected by the sample collector member 30 to be stably added to the first filling space 12 of the tube body 11.

The first material L may be a liquid or a solid such as a granule G, and an example in which the first material L is a liquid is described as an example in the present embodiment.

The tube body 11 may be made of a soft material that is elastically deformable so that dispensing is possible by a pressure applied from the outside, and a flange part 15 may be provided on an outer circumference of the opening of the tube body 11. In addition, a leakage prevention protrusion 14 that has a ring shape and elastically comes into close contact with an outer circumference of the chamber part 21 of the nozzle member 20, which will be described below, may be formed to protrude from an upper portion of an inner circumference of the tube body 11. The leakage prevention protrusion 14 may be provided as two or more leakage prevention protrusions 14 disposed at certain intervals in an axial direction to more reliably prevent leakage. The leakage prevention protrusion 14 may prevent leakage when dispensing a mixed solution that is obtained by mixing in the tube body 11 as will be described below. Meanwhile, instead of the leakage prevention protrusion 14, an O-ring may be provided on the outer circumference of the chamber part 21 of the nozzle member 20.

The piercing part 13 may be integrally formed with the tube body 11. The piercing part 13 may be formed to extend a predetermined length from an inner bottom 11a of the tube body 11 in the axial direction. Specifically, the piercing part 13 is formed to have a length that allows a front end portion of the piercing part 13 to sufficiently penetrate the second sealing film 28 when the tube member 10 and the nozzle member 20 are completely coupled. Using a hard material in forming the piercing part 13 may be considered to further facilitate piercing of the second sealing film 28, and in this case, the tube body 11 and the piercing part 13 may be separately configured and coupled to each other.

Meanwhile, the piercing part 13 may be configured in various forms but may be formed to have a structure that allows a second material G filled in the chamber part 21 of the nozzle member 20 to easily pour into the first filling space 12 of the tube member 10 after piercing. To this end, for example, as illustrated, the piercing part 13 may be configured to have a +-shaped cross-section in which four ribs 13a are radially formed. This is because, since the second sealing film 28 is forcibly torn and pierced due to a force applied to the piercing part 13 at the time of coupling between the tube member 10 and the nozzle member 20, the piercing part 13 having the +-shaped cross-section, rather than a straight or circular cross-section, is advantageous in tearing the second sealing film 28 and is advantageous in forming a gap between the second sealing film 28 and the piercing part 13 after piercing.

In addition, although not separately illustrated, the piercing part 13 may be configured to have a Y-shaped cross-section or a T-shaped cross-section. Like the +-shaped cross-section described above, the Y-shaped cross-section or the T-shaped cross-section may be advantageous in tearing the second sealing film 28 and forming a gap between the second sealing film 28 and the piercing part 13 after piercing.

The nozzle member 20 may be filled with and store the second material G to be mixed with the first material L in a sealed state and may allow a mixed solution to be discharged at the time of dispensing. To this end, the nozzle member 20 may be a configuration including the chamber part 21 that has a second filling space 22 therein to be filled with the second material G and a nozzle part 23 that allows the mixed solution to be discharged to the outside and dispensed. The nozzle member 20 may be filled with and store the second material G in a sealed state, to be mixed with the first material L, and may allow a mixed solution to be discharged at the time of dispensing.

The chamber part 21 may be configured in a cylindrical shape in order to be inserted into the inlet side of the tube body 11. An opening of an end portion at one side (a side coupled to the tube member) of the chamber part 21 is shielded by the second sealing film 28, and the second material G accommodated in the second filling space 22 is sealed. The second material G may also be a liquid or a solid such as a granule, and an example in which the second material G is a granule is described as an example in the present embodiment. The nozzle part 23 is formed to extend from an end portion at the other side of the chamber part 21 in the axial direction. The nozzle part 23 has a smaller diameter than the chamber part 21 and has a nozzle hole 24, which communicates with the second filling space 22 of the chamber part 21, formed in the axial direction.

In addition, a fitting part 21a that is fitted to a ring-shaped coupling part 33 of the sample collector member 30, which will be described below, may be formed to be stepped on the outer circumference of the chamber part 21. A flange cover part 27 that surrounds the flange part 15 of the tube member 10 may be present at a rear end of the chamber part 21, that is, between the chamber part 21 and the nozzle part 23.

For example, the nozzle hole 24 may be shielded by a cutting head part 26 provided at a front-end portion of the nozzle part 23, and accordingly, the second material G accommodated in the second filling space 22 of the chamber part 21 can be stored in a completely sealed state. A cutting part 25 is provided on an outer circumference of the front-end portion of the nozzle part 23, and the cutting head part 26 can be cut from the nozzle part 23 by applying an external force when necessary. The cutting part 25 may be configured in the form of an annular groove that is indented from an outer circumference of the nozzle part 23 and has a substantially V-shaped cross-section. Accordingly, a thickness of the nozzle part 23 that corresponds to the cutting part 25 may be configured to be very thin compared to other portions of the nozzle part 23, and in this way, the cutting head part 26 can be easily cut when an external force such as a torsional force is applied. To this end, a plurality of second handle parts 26a in the form of ribs that allow the cutting head part 26 to be easily twisted may be provided on an outer circumference of the cutting head part 26.

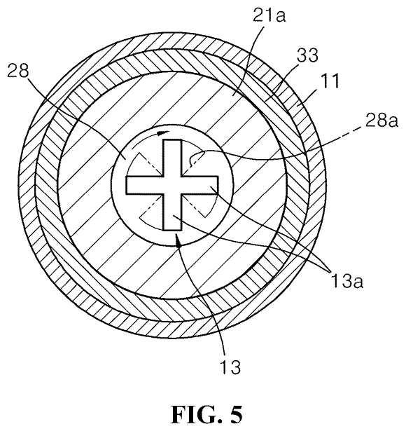

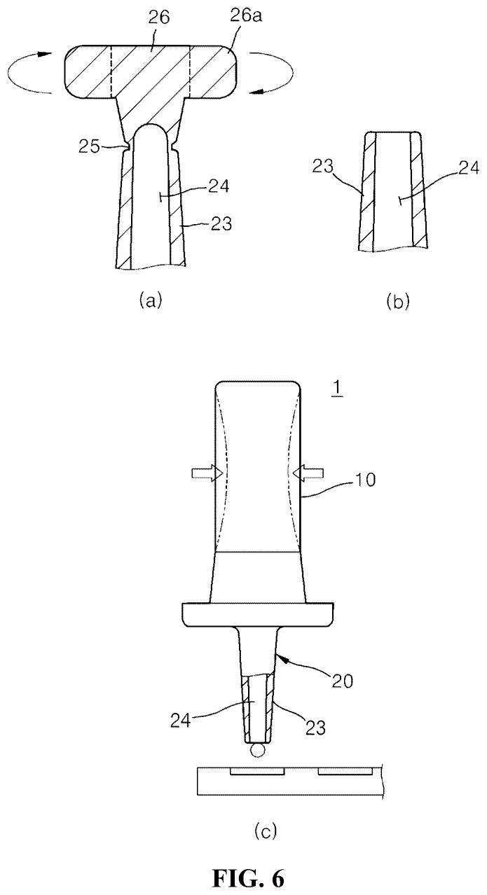

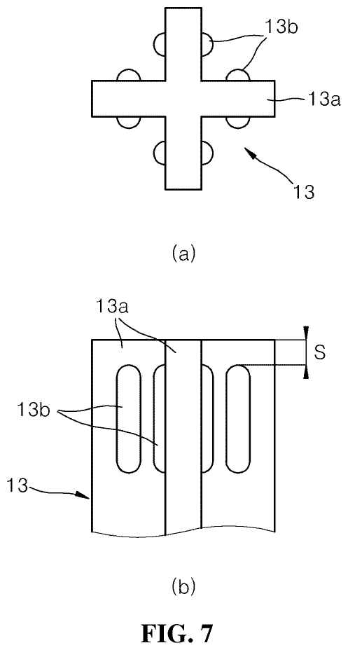

Meanwhile, as illustrated in FIG. 5, by appropriately rotating the nozzle member 20 in a circumferential direction after coupling the nozzle member 20 to the tube member 10, an inflow hole 28a may be formed wider in the second sealing film 28 penetrated by the piercing part 13. To this end, for example, a plurality of first handle parts 27a in the form of ribs may be provided together on the flange cover part 27 of the nozzle member 20 to allow the nozzle member 20 to be easily rotated after being coupled to the tube member 10.

The sample collector member 30 may be a configuration including a capillary tube part 31 that has a capillary tube hole 32 to collect a liquid specimen sample for diagnosis or analysis in predetermined fixed amounts using capillary action and the coupling part 33 that is for attaching the capillary tube part 31 to the nozzle member 20. After the sample collector member 30 collects a sample while attached to the nozzle member 20, as the nozzle member 20 is coupled to the tube member 10, the sample collector member 30 may be inserted into the first filling space 12 of the tube member 10 and may be immersed in the first material L. The liquid specimen sample may be any biological sample, specifically, blood, plasma, whole blood, serum, body fluid, amniotic fluid, aqueous humor, vitreous humor, mother milk, cerebrospinal fluid (CSF), endolymph, perilymph, gastric acid, gastric juice, lymphatic fluid, mucus, (including nasal fluid and phlegm), pericardial fluid, peritoneal fluid, pleural fluid, pus, dischargeable secretion, saliva, sebum (skin oil), semen, sweat, synovia, tears, vomitus, urine, or breath condensate, but is not limited thereto.

The capillary tube part 31 may be attached to the nozzle member 20 by being integrally connected to the coupling part 33 by a bridge part 34. The coupling part 33 may have any form as long as the coupling part 33 can attach the sample collector member 30 to the nozzle member 20. For example, as illustrated, the coupling part 33 may be a configuration that is configured in a ring shape into which the fitting part 21a of the chamber part 21 is inserted and that is able to be coupled to and separated from the nozzle member 20. The chamber part 21 and the coupling part 33 may form the same outer diameter due to the fitting part 21a formed to be stepped and thus may uniformly come into close contact with the inner circumference of the tube body 11.

Meanwhile, the sample collector member 30 may be provided as a single sample collector member having a predetermined sample collection capacity or may be provided as a plurality of sample collector members with different collection capacities, and one of the plurality of sample collector members may be selected according to a sample amount required at the time of diagnosis or testing. Different sample collection capacities may be achieved by varying the length of the capillary tube part 31 or the size or shape of the capillary tube hole 32.

The sample collector member 30 may be made of a material that is advantageous for capillary action, for example, a material with excellent hydrophilicity, or may be treated to be hydrophilic through separate chemical treatment in order to easily collect a sample such as blood using capillary action.

Meanwhile, the sample collector member 30 may be a component that is directly inserted into the first filling space 12 of the tube member 10 without being coupled to the nozzle member 20. In this case, the sample collector member 30 may only include the capillary tube part 31 without the coupling part 33 and the bridge part 34 for attaching the capillary tube part 31 to the chamber part 21 of the nozzle member 20.

A method of using the heterogeneous material mixing and dispensing device 1 of the present invention is as follows.

First, when the capillary tube part 31 of the sample collector member 30 attached to the nozzle member 20 is brought into contact with a surface of a liquid sample such as blood, the liquid sample (not illustrated) is collected in fixed amounts in the capillary tube hole 32 of the capillary tube part 31 due to capillary action.

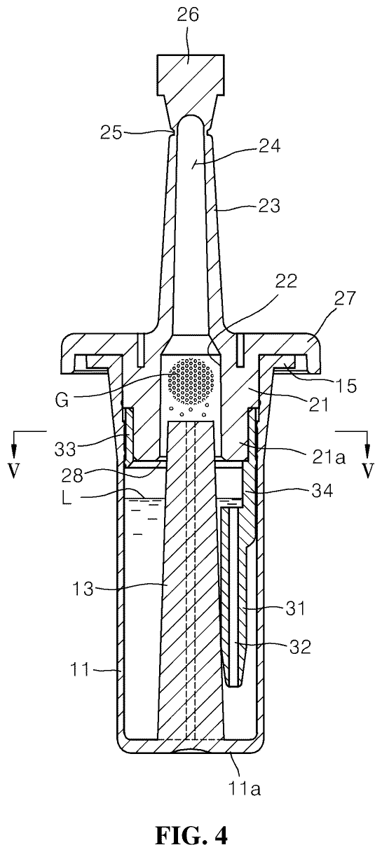

(1) Next, as in FIG. 4, the first sealing film 16 that was closing the inlet of the tube body 11 is removed in advance or appropriately torn using a separate tool. That is, when the first sealing film 16 is in a removable form like a sticker, the first sealing film 16 may be removed in advance to open the inlet of the tube member 10, and when the first sealing film 16 is in a form that should be torn, a separate tool is used to tear and pierce the first sealing film 16 to allow the sample collector member 30 that has collected the sample to enter the tube body 11. Then, after letting the sample collector member 30 enter the tube member 10 through the opening or the piercing site of the tube member 10 first, the chamber part 21 of the nozzle member 20 is fitted to the inlet side of the tube member 10.

When the nozzle member 20 and the tube member 10 are coupled, the sample collector member 30 is accommodated in the first filling space 12 of the tube member 10 and is immersed in the first material L. At this time, the front end portion of the piercing part 13 penetrates the second sealing film 28 of the nozzle member 20, and accordingly, the first and second filling spaces 12 and 22 communicate with each other. Although the above state is sufficient for allowing the second material G filled in the second filling space 22 to discharges into the first filling space 12, it may be preferable to appropriately rotate the nozzle member 20 in the circumferential direction to further facilitate the inflow. In this case, as in FIG. 5, the inflow hole 28a pierced in the second sealing film 28 can be further expanded, and thus the second material G can very easily discharges into the first filling space 12.

In this state, when the heterogeneous material mixing and dispensing device 1 of the present invention is appropriately shaken, the liquid specimen sample filled in the capillary tube hole 32 of the capillary tube part 31 flows out along with the first material L, and the first material L, the second material G, and the liquid sample can be reliably mixed in the first filling space 12.

After the first material L, the second material G, and the specimen sample are mixed, as in (a) of FIG. 6, while the tube member 10 is held with one hand, the cutting head part 26 provided on a front end of the nozzle part 23 is rotated in the circumferential direction using the second handle parts 26a with the other hand. Then, the cutting part 25 having a relatively smaller thickness than the nozzle part 23 is cut, and in this way, as in (b) of FIG. 6, the cutting head part 26 is separated from the nozzle part 23, and an outlet of the nozzle hole 24 can be opened.

Next, as in (c) of FIG. 6, when the heterogeneous material mixing and dispensing device 1 is gripped while the nozzle part 23 faces downward, and the tube body 11 is pressed by hand, the mixed solution may be discharged in the form of drops from the outlet of the nozzle hole 24 to the outside. At this time, the volume of the mixed solution being discharged may be determined by the diameter of the nozzle hole 24, and the volume of one drop may be about 25 μl to 40 μl, for example. Therefore, the mixed solution required for diagnosis or testing can be measured and dispensed in fixed amounts using the number of drops being discharged.

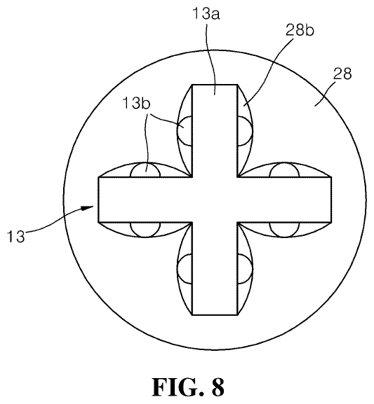

(a) and (b) of FIG. 7 and FIG. 8 schematically illustrate another embodiment of the piercing part 13 of the heterogeneous material mixing and dispensing device 1 according to the present invention.

The piercing part 13 according to this embodiment is different from the piercing part 13 according to the above-described embodiment in that at least one guide protrusion 13b is further provided on outer surfaces of the piercing part 13 having a +-shaped cross-section, that is, both outer surfaces of each of the plurality of radially arranged ribs 13a, in the longitudinal direction of the ribs 13a. The guide protrusions 13b may be positioned to be spaced a predetermined distance S from a front end of the piercing part 13. This is to, at the time of coupling between the tube member 10 and the nozzle member 20, allow the front end portion of the piercing part 13 to penetrate the second sealing film 28 first and then allow the guide protrusions 13b to enter the piercing site, thereby further widening an inflow hole 28b formed by the piercing part 13 toward both sides.

In the embodiment having such a configuration, the inflow hole 28b in the second sealing film 28 formed by the piercing part 13 can be formed large even without rotating the nozzle member 20 in the circumferential direction after the tube member 10 and the nozzle member 20 are coupled, and accordingly, the second material G accommodated in the second filling space 22 of the chamber part 21 can easily pour into the first filling space 12 of the tube member 10.

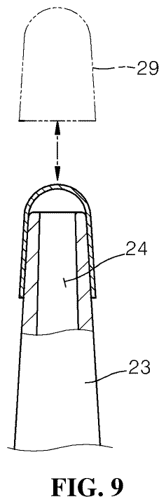

Meanwhile, FIG. 9 schematically illustrates another embodiment of an opening/closing structure of the nozzle hole 24 of the nozzle part 23 of the heterogeneous material mixing and dispensing device 1 of the present invention.

In this embodiment, the outlet of the nozzle hole 24 of the nozzle part 23 is configured in an open state, and a cap 29 is detachably mounted on the front end portion of the nozzle part 23. The cap 29 may be a component that is coupled using a simple insertion method or may be a component that is coupled using a screw coupling method. In addition, for example, a sealing material (not illustrated) such as an O-ring for sealing may, of course, be provided on the outer circumference of the front end portion of the nozzle part 23 when coupling the cap 29.

In this case, the nozzle hole 24 can be more easily opened/closed compared to the above-described embodiment.

In addition, although not separately illustrated, a screw coupling method may be adopted, and the tube body 11 and the chamber part 21 may be coupled to each other. That is, an internal screw part may be formed on an inlet-side inner circumference of the tube body 11, an external screw part may be formed on an outer circumference of the chamber part 21, and the nozzle member 20 may be rotated a predetermined angle relative to the tube member 10 to couple the tube body 11 and the chamber part 21. In this case, just by coupling the tube member 10 and the nozzle member 20, it is possible to obtain the same effect as when the chamber part 21 is fitted to the inlet side of the tube body 11, the second sealing film 28 is pierced, and then the nozzle member 20 is rotated to expand the inflow hole 28b pierced in the second sealing film 28.

Those of ordinary skill in the art to which the present invention pertains should understand that the present invention can be embodied in other specific forms without changing the technical spirit or essential features thereof. Therefore, the embodiments described above should be understood as illustrative, instead of limiting, in all aspects. The scope of the present invention is shown by the claims below rather than by the detailed description above, and all changes or modifications derived from the meaning and scope of the claims and their equivalent concepts should be construed as falling within the scope of the present invention.

1. A heterogeneous material mixing and dispensing device comprising:
a tube assembly including a tube body made of a soft material, filled with a first material, and having one end defining an inlet shielded by a shield and a piercer protruding a predetermined length from an inner surface of the other end of the tube body in an axial direction;
a nozzle assembly including a chamber filled with a second material and having one end shielded with a second sealing film and a nozzle extending from the other end of the chamber in the axial direction and configured to communicate with an inner portion of the chamber and to selectively open an outlet of the nozzle; and
a sample collector assembly configured to collect a predetermined fixed amount of a liquid specimen sample using capillary action and to be inserted into the tube body,
wherein when the nozzle assembly and the sample collector assembly are coupled to the tube assembly, the piercer penetrates the second sealing film, allowing the second material to flow into the tube body, thereby enabling mixing of the first material, the second material, and the specimen sample, and the nozzle is opened to dispense a mixed solution.

2. The heterogeneous material mixing and dispensing device of claim 1, wherein the shield comprises a first sealing film press-fitted to the inlet of the tube body.

3. The heterogeneous material mixing and dispensing device of claim 1, wherein the sample collector assembly is provided as a single sample collector assembly having a predetermined collection capacity or is provided as a plurality of sample collector assemblies with different collection capacities, and one of the plurality of sample collector assemblies is selected according to a volume of a specimen sample to be collected.

4. The heterogeneous material mixing and dispensing device of claim 3, wherein the sample collector assembly further includes a coupling connector into which an outer circumference of the chamber is inserted, the coupling connector being configured to be coupled to and decoupled from the nozzle assembly.

5. The heterogeneous material mixing and dispensing device of claim 1, wherein the piercer has a plus-shaped, Y-shaped, or T-shaped cross-section.

6. The heterogeneous material mixing and dispensing device of claim 1, wherein at least one leakage prevention protrusion is defined on an inner surface of the tube body and is configured to contact an outer surface of the chamber.

7. The heterogeneous material mixing and dispensing device of claim 1, wherein a cutting head configured to close the outlet of the nozzle is integrally defined on a front end of the nozzle, and the cutting head is configured to be cut from the nozzle through a cutting groove indented from an outer surface of the nozzle.

8. The heterogeneous material mixing and dispensing device of claim 1, wherein the outlet of the nozzle is open and is closed by a cap that is detachably coupled to a front end portion of the nozzle.

9. The heterogeneous material mixing and dispensing device of claim 1, wherein the nozzle assembly further comprises a first handle configured to rotate the nozzle assembly in a circumferential direction after the nozzle assembly is coupled to the inlet of the tube assembly in the axial direction.

10. The heterogeneous material mixing and dispensing device of claim 7, wherein the nozzle assembly further comprises a second handle configured to facilitate cutting of a cutting head.

11. The heterogeneous material mixing and dispensing device of claim 1, wherein the tube body and the chamber are coupled using a screw coupling method.

12. The heterogeneous material mixing and dispensing device of claim 5, wherein at least one guide protrusion is defined on an outer surface of the piercer in a longitudinal direction, and the guide protrusion is spaced a predetermined distance from a front end of the piercer.

13. The heterogeneous material mixing and dispensing device of claim 1, wherein when the sample collector assembly is coupled to the nozzle assembly and the coupled sample collector assembly and the nozzle assembly is coupled to the inlet of the tube body, the piercer penetrates the second sealing film.

14. The heterogeneous material mixing and dispensing device of claim 1, wherein at least one O-ring is defined on an outer surface of the chamber and is configured to contact an inner surface of the tube body.
